(19) United States
(12) Patent Application Publication
(10) Pub. No.: US 2025/0071646 A1
(43) Pub. Date: Feb. 27, 2025

(54) CELL RESELECTION MEASUREMENT METHOD AND APPARATUS THEREOF

(71) Applicant: Beijing Xiaomi Mobile Software Co., Ltd., Beijing (CN)

(72) Inventor: Xiaofei LIU, Beijing (CN)

(73) Assignee: Beijing Xiaomi Mobile Software Co., Ltd., Beijing (CN)

(21) Appl. No.: 18/689,633

(22) PCT Filed: Sep. 7, 2021
(86) PCT No.: PCT/CN2021/117051

§ 371 Date: Mar. 21, 2024

(51) Int. Cl. H04W 36/30; H04W 36/34

(52) U.S. Cl. CPC H04W 36/30; H04W 36/34

(57) ABSTRACT

Embodiments of the present disclosure disclose a cell reselection measurement method and an apparatus thereof, which may be applied in the technical field of communications. The method which is performed by a terminal device can include, in a cell reselection process, determining whether to perform measurement restriction on a cell or a frequency point that is not on a reselection candidate list.

### CROSS REFERENCE TO RELATED APPLICATIONS

The present application is a national phase application of International Application No. PCT/CN2021/117051, filed on Sep. 7, 2021, and the entire contents thereof are incorporated herein by reference.

### BACKGROUND

### Technical Field

The present disclosure relates to the field of communication technology, and in particular, to a cell reselection measurement method and an apparatus thereof.

### Description of the Related Art

In a communication system, when a terminal is in an idle state or an inactive state, it needs to continuously perform cell reselection in order to camp on a cell with higher priority or better signal quality. In the existing technology, terminal device usually determines whether to measure a cell based on frequency priority and measurement thresholds.

It should be noted that, information disclosed in the above background portion is provided only for better understanding of the background of the present disclosure, and thus it may contain information that does not form the prior art known by those ordinary skilled in the art.

### SUMMARY

Embodiments of the present disclosure provide a cell reselection measurement method and apparatus.

In a first aspect, embodiments of the present disclosure provide a method for cell reselection measurement. The method is executed by a terminal device. The method includes, during a cell reselection process, determining whether to perform a measurement restriction on a cell or a frequency outside a reselection candidate list.

Optionally, the measurement restriction includes any of the following: not performing measurement, performing measurement relaxation, and adding the cell or frequency point outside the reselection candidate list to a reselection blacklist cell.

Optionally, the reselection blacklist cell includes at least one of the following indicated in a broadcast system message: an intra-frequency blacklisted cell list, an inter-frequency blacklisted cell list, or an inter-system blacklisted cell list.

Optionally, the determining whether to perform the measurement restriction on the cell or frequency point outside the reselection candidate list includes determining whether to perform the measurement restriction on the cell or frequency point outside the reselection candidate list according to a protocol agreement, or determining whether to perform the measurement restriction on the cell or frequency point outside the reselection candidate list according to first indication information sent by a network device.

Optionally, the according to first indication information sent by the network device includes receiving the first indication information by a broadcast system messages in a serving cell, or receiving the first indication information by a dedicated signaling.

Optionally, the method further including determining an active duration of the measurement restriction according to second indication information of the network device, or determining the active duration of the measurement restriction according to a protocol agreement.

Optionally, performing measurement relaxation includes determining at least one of following measurement parameters number of measurements, or measurement period.

Optionally, the method further including performing at least one measurement on the cell or frequency point outside the reselection candidate list in each measurement period.

Optionally, the method further including determining the measurement parameters according to third indication information of the network device, or determining the measurement parameters according to a protocol agreement.

Optionally, wherein the measurement parameters corresponding to different frequency points are different or same, the measurement parameters corresponding to different cells are different or same, the measurement parameters corresponding to terminal device in different states are different or same, or the measurement parameters corresponding to terminal device of different services are different or same.

Optionally, the performing at least one measurement on the cell or frequency point outside the reselection candidate list in each measurement period includes, in response to any measurement period being aligned with a discontinuous reception DRX cycle, performing at least one measurement on the cell or frequency point outside the reselection candidate list in the any measurement period, or, in response to any measurement period being misaligned with the DRX cycle, performing at least one measurement on the cell or frequency point outside the reselection candidate list in the DRX cycle after the any measurement period.

Optionally, the terminal device is configured with extended DRX, and the method further includes, in a case that it is determined to perform measurement restriction on the cell or frequency point outside the reselection candidate list, in response to determining that there is a paging time window PTW within an active duration of the measurement restriction, performing at least one measurement on the cell or frequency point outside the reselection candidate list in the DRX cycle of the PTW.

Optionally, the in response to determining that there is the paging time window PTW within the active duration of the measurement restriction, performing at least one measurement on the cell or frequency point outside the reselection candidate list in the DRX cycle of the PTW, includes, in response to determining that one PTW exists within the active duration of the measurement restriction, performing at least one measurement on the cell or frequency point outside the reselection candidate list in the DRX cycle of the one PTW, or, in response to determining that at least two PTWs exist within the active duration of the measurement restriction, performing at least one measurement on the cell or frequency point outside the reselection candidate list in the DRX cycle of at least one PTW among the at least two PTWs.

Optionally, the terminal device is configured with extended DRX, and the method further includes, in a case that it is determined to perform measurement restriction on the cell or frequency point outside the reselection candidate list, in response to determining that there is no paging time window PTW within an active duration of the measurement restriction, not performing measurement on the cell or frequency point outside the reselection candidate list.

Optionally, the cell reselection process includes at least one of the following: intra-frequency cell reselection, inter-frequency cell reselection, or inter-system cell reselection.

In a second aspect, embodiments of the present disclosure provide a method for cell reselection measurement. The method is executed by a terminal device. The method includes: sending first indication information to a terminal device, wherein the first indication information is configured to indicate whether to perform a measurement restriction on a cell or frequency point outside a reselection candidate list during a cell reselection process.

Optionally, the measurement restriction includes any of the following: not performing measurement, performing measurement relaxation, and adding the cell or frequency point outside the reselection candidate list to a reselection blacklist cell.

Optionally, the reselection blacklist cell includes at least one of the following indicated in a broadcast system message: an intra-frequency blacklisted cell list, an inter-frequency blacklisted cell list, or an inter-system blacklisted cell list.

Optionally, the sending the first indication information to the terminal device includes sending the first indication information to the terminal device by a broadcast system messages in a serving cell, or sending the first indication information to the terminal device by a dedicated signaling.

Optionally, the method further including sending second indication information to the terminal device, wherein the second indication information is configured to indicate an active duration of the measurement restriction.

Optionally, the method further including sending third indication information to the terminal device, wherein the third indication information is configured to indicate measurement parameters, and wherein the measurement parameters include at least one of following: number of measurements; or measurement period.

Optionally, the measurement parameters corresponding to different frequency points are different or same, the measurement parameters corresponding to different cells are different or same, the measurement parameters corresponding to terminal device in different states are different or same, or the measurement parameters corresponding to terminal device of different services are different or same.

Optionally, the cell reselection process includes at least one of the following: intra-frequency cell reselection, inter-frequency cell reselection, or inter-system cell reselection.

In a third aspect, embodiments of the present disclosure provide a communication apparatus that has some or all of the functions of the terminal device for implementing the method described in the first aspect. For example, the functions of the communication apparatus may have some or all of the functions of the present disclosure. The functions in the embodiments may also be used to independently implement any of the embodiments of the present disclosure. The functions described can be implemented by hardware, or can be implemented by hardware executing corresponding software. The hardware or software includes one or more units or modules corresponding to the above functions.

In the fourth aspect, embodiments of the present disclosure provide another communication apparatus that has some or all of the functions of the network device for implementing the method described in the second aspect. For example, the functions of the communication apparatus may have some or all of the functions of the present disclosure. The functions in the embodiments may also be used to independently implement any of the embodiments of the present disclosure. The functions described can be implemented by hardware, or can be implemented by hardware executing corresponding software. The hardware or software includes one or more units or modules corresponding to the above functions.

In a fifth aspect, an embodiment of the present disclosure provides a communication apparatus. The communication apparatus includes a processor. When the processor calls a computer program in a memory, it executes the method described in the first aspect.

In a sixth aspect, an embodiment of the present disclosure provides a communication apparatus. The communication apparatus includes a processor. When the processor calls a computer program in a memory, it executes the method described in the second aspect.

In a seventh aspect, an embodiment of the present disclosure provides a communication apparatus. The communication apparatus includes a processor and a memory, and a computer program is stored in the memory; when the computer program is executed by the processor, the communication apparatus is caused to execute the method described in the first aspect.

In an eighth aspect, an embodiment of the present disclosure provides a communication apparatus. The communication apparatus includes a processor and a memory, and a computer program is stored in the memory; when the computer program is executed by the processor, the communication apparatus is caused to execute the method described in the second aspect.

In a ninth aspect, an embodiment of the present disclosure provides a communication apparatus. The apparatus includes a processor and an interface circuit. The interface circuit is used to receive code instructions and transmit the code instructions to the processor. The processor is used to run the code instructions to cause the apparatus to perform the method described in the first aspect.

In a tenth aspect, an embodiment of the present disclosure provides a communication apparatus. The apparatus includes a processor and an interface circuit. The interface circuit is used to receive code instructions and transmit them to the processor. The processor is used to run the code instructions to cause the apparatus to perform the method described in the second aspect above.

In an eleventh aspect, an embodiment of the present disclosure provides a communication system, which includes the communication apparatus described in the third aspect and the communication apparatus described in the fourth aspect, or the system includes the communication apparatus described in the fifth aspect and the communication apparatus described in the sixth aspect, or the system includes the communication apparatus described in the seventh aspect and the communication apparatus described in the eighth aspect, or the system includes the communication apparatus described in the ninth aspect and the communication apparatus described in the tenth aspect.

In a twelfth aspect, embodiments of the present invention provide a computer-readable storage medium for storing instructions used by the terminal device. When the instructions are executed, the method described in the first aspect is implemented.

In a thirteenth aspect, embodiments of the present invention provide a computer-readable storage medium for storing instructions used by the network device. When the instructions are executed, the method described in the second aspect is implemented.

In a fourteenth aspect, the present disclosure also provides a computer program product including a computer program, which when run on a computer causes the computer to execute the method described in the first aspect.

In a fifteenth aspect, the present disclosure also provides a computer program product including a computer program, which, when run on a computer, causes the computer to execute the method described in the second aspect.

In a sixteenth aspect, the present disclosure provides a chip system, which includes at least one processor and an interface for supporting a terminal device to implement the functions involved in the first aspect, for example, determining or processing at least one of data and information involved in the above method. In a possible design, the chip system further includes a memory, and the memory is used to store necessary computer programs and data for the terminal device. The chip system may be composed of chips, or may include chips and other discrete devices.

In a seventeenth aspect, the present disclosure provides a chip system, which includes at least one processor and an interface for supporting a network device to implement the functions involved in the second aspect, for example, determining or processing at least one of data and information involved in the above method. In a possible design, the chip system further includes a memory, and the memory is used to store necessary computer programs and data for the network device. The chip system may be composed of chips, or may include chips and other discrete devices.

In an eighteenth aspect, the present disclosure provides a computer program that, when run on a computer, causes the computer to execute the method described in the first aspect.

In a nineteenth aspect, the present disclosure provides a computer program that, when run on a computer, causes the computer to perform the method described in the second aspect.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

In order to more clearly illustrate the technical solutions in the embodiments of the disclosure or the background technology, the drawings required to be used in the embodiments or the background technology of the disclosure will be described below.

FIG. 1 is a schematic architectural diagram of a communication system provided by an embodiment of the present disclosure;

FIG. 2 is a schematic flowchart of a cell reselection measurement method provided by an embodiment of the present disclosure;

FIG. 3 is a schematic flowchart of a cell reselection measurement method provided by another embodiment of the present disclosure;

FIG. 4 is a schematic flowchart of a cell reselection measurement method provided by another embodiment of the present disclosure;

FIG. 5 is a schematic flowchart of a cell reselection measurement method provided by another embodiment of the present disclosure;

FIG. 6 is a schematic flowchart of a cell reselection measurement method provided by another embodiment of the present disclosure;

FIG. 7 is a schematic flowchart of a cell reselection measurement method provided by another embodiment of the present disclosure;

FIG. 8 is a schematic flowchart of a cell reselection measurement method provided by another embodiment of the present disclosure;

FIG. 9 is a schematic flowchart of a cell reselection measurement method provided by another embodiment of the present disclosure;

FIG. 10 is a schematic flowchart of a cell reselection measurement method provided by another embodiment of the present disclosure;

FIG. 11 is a schematic structural diagram of a communication apparatus according to an embodiment of the present disclosure;

FIG. 12 is a schematic structural diagram of a communication apparatus according to another embodiment of the present disclosure; and

FIG. 13 is a schematic structural diagram of a chip according to an embodiment of the present disclosure.

### DETAILED DESCRIPTION OF THE PREFERRED EMBODIMENTS

In order to better understand the cell reselection measurement method disclosed in the embodiment of the present disclosure, the communication system to which the embodiment of the present disclosure is applicable is first described below.

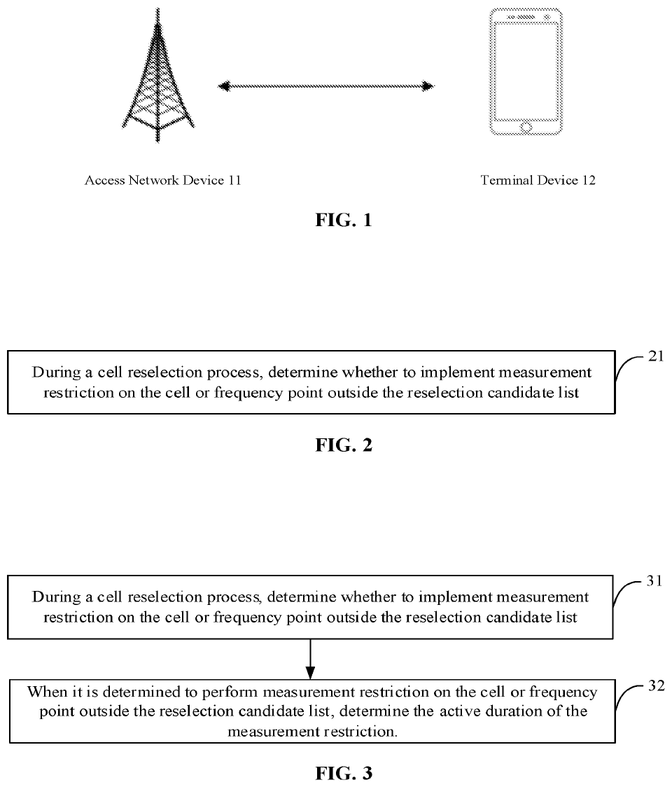

Please refer to FIG. 1, which is a schematic architectural diagram of a communication system provided by an embodiment of the present disclosure. The communication system may include but is not limited to one network device and one terminal device. The number and form of devices shown in FIG. 1 are only for examples and do not constitute a limitation on the embodiments of the present disclosure. In actual applications, two or more network devices and two or more terminal devices may be included. The communication system shown in FIG. 1 includes a network device 11 and a terminal device 12 as an example.

It should be noted that the technical solutions of the embodiments of the present disclosure can be applied to various communication systems. For example: long term evolution (LTE) system, fifth generation (5G) mobile communication system, 5G new radio (NR) system, or other future new mobile communication systems.

The network device 11 in the embodiment of the present disclosure is an entity on the network side that is used to transmit or receive signals. For example, the network device 11 may be an evolved base station (evolved NodeB, eNB), a transmission reception point (TRP), a next generation base station (next generation NodeB, gNB) in an NR system, other base stations in future mobile communication systems, or access nodes in wireless fidelity (WiFi) systems, etc. The embodiments of the present disclosure do not limit the specific technologies and specific equipment forms used by network device. The network device provided by the embodiments of the present disclosure may be composed of a central unit (CU) and a distributed unit (DU). The CU may also be called a control unit (control unit). By using the CU-DU structure, it can separate the protocol layers of network device, such as base stations, and place some protocol layer functions under centralized control on the CU. The remaining part or all protocol layer functions are distributed in the DU, and the CU centrally controls the DU.

The terminal device 12 in the embodiment of the present disclosure is an entity on the user side for receiving or transmitting signals, such as a mobile phone. The terminal device can also be referred to as terminal, user equipment (UE), mobile station (MS), mobile terminal (MT), etc. The terminal devices can be cars with communication functions, smart cars, mobile phones, wearable devices, tablets (Pads), computers with wireless transceiver functions, virtual reality (VR) terminal devices, augmented reality (AR) terminal device, wireless terminal device in industrial control, wireless terminal device in self-driving, wireless terminal device in remote medical surgery, wireless terminal device in smart grid, wireless terminal device in transportation safety, wireless terminal device in smart city, wireless terminal device in smart home, etc. The embodiments of the present disclosure do not limit the specific technology and specific form used by the terminal device.

It can be understood that the communication system described in the embodiments of the present disclosure is to more clearly illustrate the technical solutions of the embodiments of the present disclosure, and does not constitute a limitation on the technical solutions provided by the embodiments of the present disclosure. As those of ordinary skill in the art will know, with the evolution of system architecture and the emergence of new service scenarios, the technical solutions provided by the embodiments of the present disclosure are also applicable to similar technical problems.

The cell reselection measurement method and apparatus provided by the present disclosure will be introduced in detail below with reference to the accompanying drawings.

Please refer to FIG. 2. FIG. 2 is a schematic flowchart of a cell reselection measurement method provided by an embodiment of the present disclosure. The method is executed by a terminal device. As shown in FIG. 2, the method may include but is not limited to the following steps:
Step 21: During a cell reselection process, determine whether to implement measurement restriction on the cell or frequency point outside the reselection candidate list.

It should be noted that during the cell reselection process, the terminal device will determine the target cell based on the reselection conditions and criteria when communicating. The terminal device can then read the system information of the target cell and determine whether the cell is a suitable cell based on the parameters in the system information. If so, it will be reselected to the cell. If not, it will be determined according to the protocol whether the cell needs to be excluded from reselection candidate cells. For example, if the cell is considered a barred cell according to the cell status indication or the inability to obtain system information, the cell and/or other cells on the same frequency may be excluded from reselection candidate cells for 300 seconds, or the like.

If a cell or frequency point is excluded from reselection candidate cells, that is, the cell or frequency point is currently in a reselection restricted state and cannot be reselected as a target cell by the terminal device. At this time, if the terminal device still performs measurement on the cell or frequency point outside the reselection candidate list, it will not only cause power consumption, but also occupy the measurement opportunities of other reselection candidate frequencies or cells, resulting in inaccurate measurement results of other reselection candidate frequencies or cells. Therefore, in the present disclosure, during the reselection process of the terminal device, it can be determined as needed whether to perform measurement restriction on the cell or frequency point outside the reselection candidate list.

Optionally, the cell reselection process may include at least one of the following: intra-frequency cell reselection, inter-frequency cell reselection, and inter-system (inter-RAT) cell reselection.

The intra-frequency cell reselection may be that the terminal device selects a new serving cell from a list of reselection candidate cells with the same frequency according to the frequency of the current serving cell.

The inter-frequency cell reselection may be that the terminal device selects a new serving cell from a list of reselection candidate cells with different frequencies according to the frequency of the current serving cell.

The inter-system cell reselection may be that the terminal device selects a new serving cell from a list of reselection candidate cells included in different systems according to the system in which the current serving cell is located. For example, the serving cell where the terminal device is currently located is the 4G system, and the terminal device can select a new serving cell from the reselection candidate cells included in the 5G system. This disclosure does not limit this.

Optionally, the measurement restriction may include any of the following: not performing measurement, performing measurement relaxation, and adding cell or frequency point outside the reselection candidate list to the reselection blacklist cell.

For example, when the measurement restriction is to not perform measurements, during the cell reselection process, if the terminal device detects a cell on a certain frequency point and the cell is excluded from the reselection candidate list, then the terminal device may not perform measurements on the cell.

Alternatively, during the cell reselection process, if the terminal device determines that all cells under a certain frequency point are excluded from the reselection candidate list, the terminal device may not perform measurements on the frequency point. In the embodiment, the frequency points for which measurement is not performed can be high-priority frequency points, same-priority frequency points, or low-priority frequency points. This disclosure does not limit this.

Alternatively, during the intra-frequency cell reselection process, if the terminal device determines that all the intra-frequency neighboring cells are excluded from the reselection candidate list, the terminal device may not perform measurements on the intra-frequency cells.

Optionally, the reselection blacklist cell may include at least one of the following indicated in the broadcast system message: Intra-frequency blacklist cell list (Intra Freq Black Cell List), inter-frequency blacklist cell list (Inter Freq Black Cell List), and inter-system blacklist cell list (EUTRA-Freq Black Cell List).

The broadcast system message may be a message broadcast by the serving cell where the terminal device is currently located.

For example, during the cell reselection process, if a cell is excluded from the reselection candidate list, the terminal device will add the cell to the reselection blacklist. If it is determined to perform measurement restriction, when performing cell reselection measurement, the terminal device will not perform measurements on cells that have been added to the reselection blacklist due to reselection restrictions. When the reselection restriction of a certain cell or a certain frequency point is removed, the cell or all cells under this frequency point can be removed from the reselection blacklist, and the reselection measurement evaluation can be performed again.

By implementing the embodiments of the present disclosure, the terminal device determines whether to perform measurement restriction on cell or frequency point outside the reselection candidate list during the cell reselection process. As a result, the terminal device limits the measurement of cell or frequency point outside the reselection candidate list and avoids cell or frequency point outside the reselection candidate list from occupying measurement opportunities. This not only ensures the accuracy of the measurement results, but also reduces the power consumption of the terminal device.

Please refer to FIG. 3. FIG. 3 is a schematic flowchart of a cell reselection measurement method provided by another embodiment of the present disclosure. The method is executed by a terminal device. As shown in FIG. 3, the method may include but is not limited to the following steps:
Step 31: During the cell reselection process, determine whether to perform a measurement restriction on the cell or frequency point outside the reselection candidate list.

Optionally, the terminal device may determine whether to perform measurement restriction on the cell or frequency point outside the reselection candidate list according to the first indication information of the network device.

The first indication information is a message sent by the network device to the terminal device, used to instruct the terminal device whether to perform measurement restriction on the cell or frequency point outside the reselection candidate list.

Optionally, the terminal device may receive the first indication information through a broadcast system message of the serving cell.

Alternatively, the terminal device may also receive the first indication information through dedicated signaling.

Optionally, the terminal device may also determine whether to perform measurement restriction on the cell or frequency point outside the reselection candidate list according to the protocol agreement.

Step 32: When it is determined to perform measurement restriction on the cell or frequency point outside the reselection candidate list, determine the active duration of the measurement restriction.

Optionally, the terminal device may determine the active duration of the measurement restriction based on the second indication information of the network device.

Alternatively, the terminal device can also determine the active duration of the measurement restriction according to the protocol agreement.

Optionally, the active duration T1 of the measurement restriction and the active duration T2 of the reselection restriction may be the same or different, and this disclosure does not limit this.

For example, when the active duration T1 of the measurement restriction is the same as the active duration T2 of the reselection restriction, and the active duration T2 of the reselection restriction is 300 s, then the active duration T1 of the measurement restriction is also 300 s. Alternatively, the active duration T2 of the reselection restriction can be up to 300 s. For example, if T2 is 280 s, then it is determined that the active duration T1 of the measurement restriction is also 280 s. This disclosure does not limit this.

When the active duration T1 of the measurement restriction is different from the active duration T2 of the reselection restriction, and the active duration T2 of the reselection restriction is 300 s, then the active duration T1 of the measurement restriction can be 200 s, 250 s, etc. Alternatively, the active duration T2 of the reselection restriction can be up to 300 s. For example, if T2 is 280 s, then the active duration T1 of the measurement restriction can be 200 s, 260 s, etc. This disclosure does not limit this.

Optionally, the measurement restriction removing time and the reselection restriction removing time may be the same or different, and this disclosure does not limit this.

It can be understood that during the cell reselection process, if the active duration of the measurement restriction is the same as the active duration of the reselection restriction, the measurement restriction will be removed at the same time when the reselection restriction of the cell or frequency point is removed. Therefore, it is avoided that the cell or frequency point has been removed from the reselection restriction, while the terminal device still performs measurement restriction on the cell or frequency point that has been removed from the reselection restriction, further ensuring the accuracy of the measurement results.

Correspondingly, during the cell reselection process, if the active duration of the measurement restriction is irrelevant to the active duration of the reselection restriction, measurement restriction will be implemented on the cell or frequency point outside the reselection candidate list within the determined active duration of the measurement restriction. After the measurement restriction is removed, the measurement restriction is removed for cell or frequency point outside the reselection candidate list. Accordingly, during the active duration of the measurement restriction, the power consumption of the terminal device is reduced, and the measurement opportunities may be avoided from being occupied by the reselection of cell or frequency point outside the candidate list.

By implementing the embodiments of the present disclosure, when the terminal device determines to perform measurement restriction on the cell or frequency point outside the reselection candidate list during the cell reselection process, the terminal device determines the active duration of the measurement restriction. As a result, the terminal device performs measurement restriction on cell or frequency point outside the reselection candidate list within the active duration of the measurement restriction, and resumes normal measurement of the cell or frequency point after the measurement restriction is removed, thus avoiding the reselection of cell or frequency point outside the candidate list from occupying the measurement opportunities, which not only ensures the accuracy of measurement results, but also reduces the power consumption of terminal device.

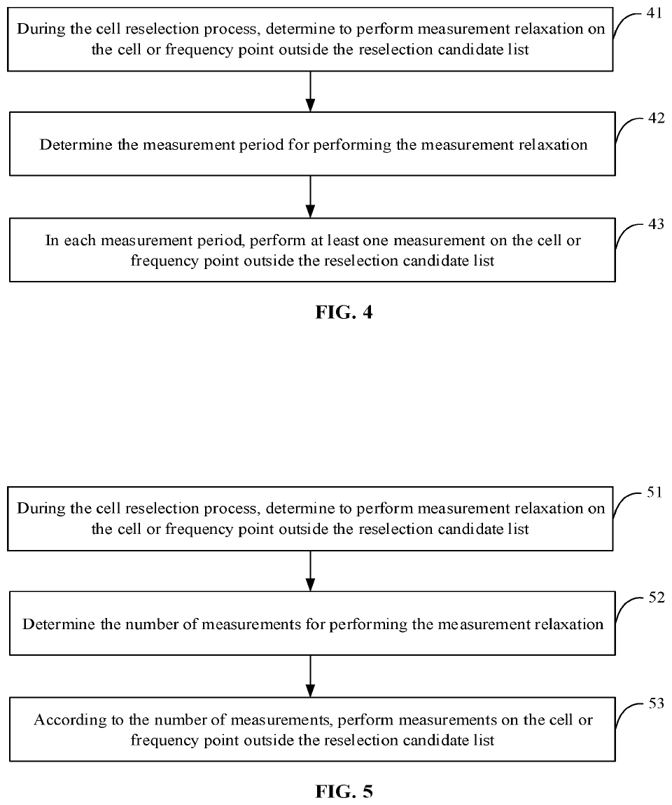

Please refer to FIG. 4. FIG. 4 is a schematic flowchart of a cell reselection measurement method provided by another embodiment of the present disclosure. The method is executed by a terminal device. As shown in FIG. 4, the method may include but is not limited to the following steps:
Step 41. During the cell reselection process, determine to perform measurement relaxation on the cell or frequency point outside the reselection candidate list.

For the implementation process of the step 41, reference can be made to the detailed description of any embodiment of the present disclosure, and will not be described again here.
Step 42: Determine the measurement period for performing the measurement relaxation.

Optionally, performing measurement relaxation may include determining at least one of the following measurement parameters: the number of measurements, and the measurement period.

Optionally, the terminal device may determine the measurement parameters according to the third indication information of the network device.

Alternatively, the terminal device can also determine the measurement parameters according to the protocol agreement.

The number of measurements is the number of times the terminal device performs measurements on cells outside the reselection candidate list.

It can be 1 time, 2 times, N times, etc., and this disclosure does not limit this.

Optionally, the measurement period may be the product of the regular measurement period of the terminal device and the measurement relaxation factor. The measurement relaxation factor may be determined based on the third indication information of the network device, or may be determined according to the protocol agreement, which is not limited in this disclosure.

Alternatively, the measurement period can also be determined based on the number of measurements. That is, the measurement period is the ratio of the duration of the measurement restriction to the number of measurements.

Alternatively, the measurement period can also be a specific period configured by the network device or agreed by the protocol. For example, a measurement is performed every 50 seconds, a measurement is performed every 100 seconds, etc. This disclosure does not limit this.

Optionally, the measurement parameters corresponding to different frequency points can be different or the same, the measurement parameters corresponding to different cells can be different or the same, the measurement parameters corresponding to terminal device in different states can be different or the same, or the measurement parameters corresponding to terminal device of different services may be different or the same.
Step 43: In each measurement period, perform at least one measurement on the cell or frequency point outside the reselection candidate list.

Optionally, in the case where any measurement period is aligned with a discontinuous reception (DRX) period, at least one measurement is performed on a cell or frequency point outside the reselection candidate list in the any measurement period.

Alternatively, in the case where any measurement period is not aligned with the DRX period, at least one measurement is performed on a cell or frequency point outside the reselection candidate list in the DRX period after the any measurement period.

Optionally, at least one measurement can be performed on the cell or frequency point outside the reselection candidate list in the first one of DRX cycle after the any measurement cycle;

Or, it is also possible that at least one measurement can be performed on the cell or frequency point outside the reselection candidate list in the X-th one of DRX cycle after the any measurement cycle, where X is a positive integer greater than 1.

By implementing the embodiments of the present disclosure, when the terminal device determines to perform measurement relaxation on a cell or frequency point outside the reselection candidate list during the cell reselection process, it can first determine the measurement period, and then in each measurement period, at least one measurement is performed on cell or frequency point outside the reselection candidate list, which avoids cell or frequency point outside the reselection candidate list from taking up too many measurement opportunities. This not only ensures the accuracy of the measurement results, but also reduces the power consumption of the terminal device.

Please refer to FIG. 5. FIG. 5 is a schematic flowchart of a cell reselection measurement method provided by another embodiment of the present disclosure. The method is executed by a terminal device. As shown in FIG. 5, the method may include but is not limited to the following steps:
Step 51. During the cell reselection process, determine to perform measurement relaxation on the cell or frequency point outside the reselection candidate list. For the specific implementation form of step 51, reference can be made to the detailed steps in other embodiments of this disclosure, and will not be described in detail here.
Step 52. Determine the number of measurements for performing the measurement relaxation. Optionally, the number of measurements may be indicated by the network device, or may be determined according to the protocol agreement, which is not limited in this disclosure.
Step 53: According to the number of measurements, perform measurements on the cell or frequency point outside the reselection candidate list.

It should be noted that after the terminal device determines the number of measurements, when performing measurements on a cell or frequency point outside the reselection candidate list, it needs to ensure that the time when the measurement is performed is within the DRX cycle.

Optionally, in response to the terminal device determining that the measurement time is not within the DRX cycle, it is determined that within the first one DRX cycle or the Y-th DRX cycle after the measurement time, the measurement is performed on the cell or frequency point outside the reselection candidate list, where Y is a positive integer greater than 1.

Optionally, in response to the terminal device determining that the measurement time is within the DRX cycle, the measurement is performed on cell or frequency point outside the reselection candidate list at the measurement time.

By implementing the embodiments of the present disclosure, during the cell reselection process, the terminal device determines to perform measurement relaxation on cell or frequency point outside the reselection candidate list. It can first determine the number of measurements, and then perform measurements on cell or frequency point outside the reselection candidate list according to the number of measurements, which avoids cell or frequency point outside the reselection candidate list from occupying too many measurement opportunities. This not only ensures the accuracy of the measurement results, but also reduces the power consumption of the terminal device.

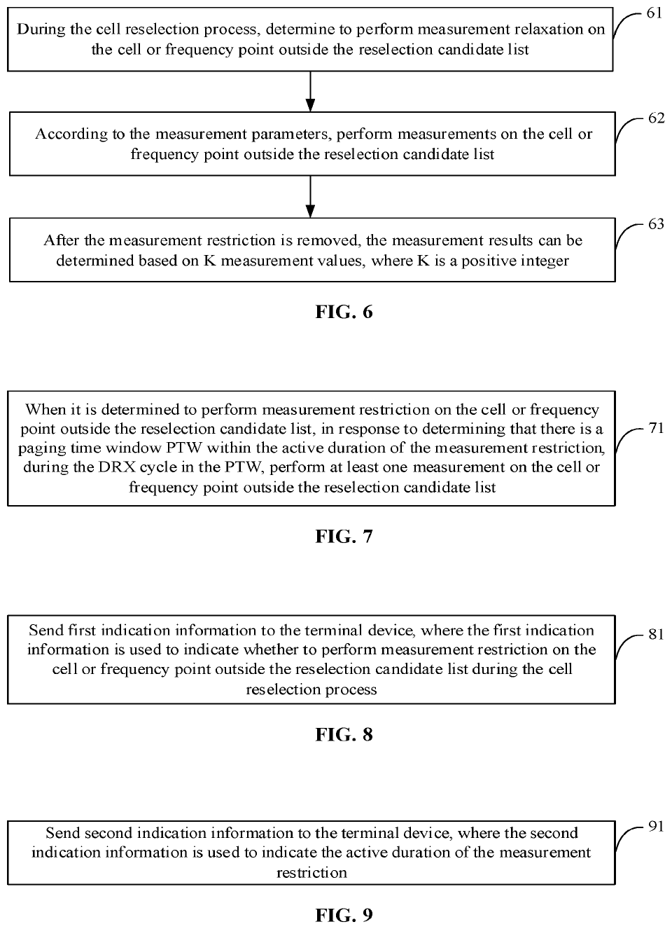

Please refer to FIG. 6. FIG. 6 is a schematic flowchart of a cell reselection measurement method provided by another embodiment of the present disclosure. The method is executed by a terminal device. As shown in FIG. 6, the method may include but is not limited to the following steps:
Step 61: During the cell reselection process, determine to perform measurement relaxation on the cell or frequency point outside the reselection candidate list.
Step 62: According to the measurement parameters, perform measurements on the cell or frequency point outside the reselection candidate list. For specific implementation forms of step 61 and step 62, reference can be made to the detailed steps in other embodiments of this disclosure, and will not be described in detail here.
Step 63: After the measurement restriction is removed, the measurement results can be determined based on K measurement values, where K is a positive integer. Optionally, the value of K can be configured as needed, for example, it can be 2, 3, etc. In the embodiment, the K measurement values may be the latest measurement values within the active duration of the measurement restriction, or they may also be the measurement values corresponding to the specified number of measurements within the active duration of the measurement restriction, etc. This disclosure does not limit this.

Optionally, after the measurement restriction is removed, the measurement results of the cells are determined based on K measurement values corresponding to the cells outside the reselection candidate list.

Optionally, after the measurement restriction is removed, the measurement results of the frequency points are determined based on K measurement values corresponding to the frequency point outside the reselection candidate list.

Alternatively, after the measurement restriction is removed, if more accurate measurement results are needed, cell or frequency reselection outside the reselection candidate list can be measured, and this disclosure does not limit this.

It should be noted that the terminal device needs to filter at least two measurement values to determine the measurement result of the cell or frequency point, and the measurement time interval between the two measurement values is not less than half of the measurement period.

By implementing the embodiments of the present disclosure, the terminal device can determine the measurement result based on K measurement values after the measurement restriction is removed. Therefore, when the terminal device performs measurement relaxation on the cell or frequency point outside the reselection candidate list, the terminal device performs measurements on the cell or frequency point outside the reselection candidate list, so that after the reselection restriction is removed, the terminal device can directly determine the measurement results by using the measurement values when measurement relaxation is performed on the cell or frequency point outside the reselection candidate list, thereby reducing latency.

Please refer to FIG. 7. FIG. 7 is a schematic flowchart of a cell reselection measurement method provided by another embodiment of the present disclosure. The method is executed by a terminal device. As shown in FIG. 7, the method may include but is not limited to the following steps:
Step 71: When it is determined to perform measurement restriction on the cell or frequency point outside the reselection candidate list, in response to determining that there is a paging time window (PTW) within the active duration of the measurement restriction, during the DRX cycle in the PTW, perform at least one measurement on the cell or frequency point outside the reselection candidate list.

It can be understood that when the terminal device is configured with extended DRX, if there is a paging window within the active duration of the measurement restriction, at least one measurement can be performed on the cell or frequency point outside the reselection candidate list during the DRX cycle in the PTW, which further reduces the power consumption of the terminal device.

Optionally, when it is determined that a PTW exists within the active duration of the measurement restriction, perform at least one measurement on the cell or frequency point outside the reselection candidate list within the DRX cycle of a PTW.

Alternatively, when it is determined that at least two PTWs exist within the active duration of the measurement restriction, perform at least one measurement on the cell or frequency point outside the reselection candidate list within the DRX cycle of at least one PTW among the at least two PTWs.

For example, the terminal device may perform at least one measurement on a cell or frequency point outside the reselection candidate list within the DRX cycle of two PTWs, respectively. For example, the terminal device may also determine according to regulations to perform at least one measurement on the cell or frequency point outside the reselection candidate list within the DRX cycle of first two PTWs, respectively. Alternatively, the terminal device may also determine, according to regulations, to perform at least one measurement on the cell or frequency point outside the reselection candidate list within the DRX cycle of the N-th and (N+M)-th PTWs, respectively.

The terminal device may also perform at least one measurement on the cell or frequency point outside the reselection candidate list within the DRX cycle of at least two PTWs, respectively. For example, the terminal device performs at least one measurement in the DRX cycle of each PTW. Alternatively, the terminal device can also perform at least one measurement in the DRX cycle of every P PTMs according to regulations.

Optionally, the terminal device is configured with extended DRX. When it is determined to perform measurement restriction on the cell or frequency point outside the reselection candidate list, in response to determining that there is no paging time window PTW within the measurement restriction duration, no measurement is performed on the cell or frequency point outside the reselection candidate list.

By implementing the embodiments of the present disclosure, when the terminal device determines to perform measurement restriction on the cell or frequency point outside the reselection candidate list, in response to determining that the paging time window PTW exists within the active duration of the measurement restriction, at least one measurement is performed on the cell or frequency point outside the reselection candidate list within the DRX cycle of the PTW. In this way, the terminal device performs at least one measurement on the cell or frequency point outside the reselection candidate list during the DRX cycle of the PTW, thereby not only further reducing the power consumption of the terminal device, but also ensuring the accuracy of the measurement results.

Please refer to FIG. 8. FIG. 8 is a schematic flowchart of a cell reselection measurement method provided by another embodiment of the present disclosure. The method is executed by a network device. As shown in FIG. 8, the method may include but is not limited to the following steps:
Step 81: Send first indication information to the terminal device, where the first indication information is used to indicate whether to perform measurement restriction on the cell or frequency point outside the reselection candidate list during the cell reselection process. Optionally, the network device may send the first indication information to the terminal device through broadcast system message of the serving cell.

Alternatively, the network device may also send the first indication information to the terminal device through dedicated signaling.

Optionally, the cell reselection process may include at least one of the following: intra-frequency cell reselection, inter-frequency cell reselection, and inter-system cell reselection.

The intra-frequency cell reselection may be that the terminal device selects a new serving cell from a list of reselection candidate cells with the same frequency according to the frequency of the current serving cell.

The inter-frequency cell reselection may be that the terminal device selects a new serving cell from a list of reselection candidate cells with different frequencies according to the frequency of the current serving cell.

The inter-system cell reselection may be that the terminal device selects a new serving cell from a list of reselection candidate cells included in different systems according to the system in which the current serving cell is located. For example, the serving cell where the terminal device is currently located is the 4G system, and the terminal device can select a new serving cell from the reselection candidate cells included in the 5G system. This disclosure does not limit this.

Optionally, the reselection blacklist cell may include at least one of the following indicated in the broadcast system message: Intra-frequency blacklist cell list, inter-frequency blacklist cell list, and inter-system blacklist cell list.

The broadcast system message may be a message broadcast by the serving cell where the terminal device is currently located.

For example, during the cell reselection process, if a cell is excluded from the reselection candidate list, the terminal device will add the cell to the reselection blacklist. If it is determined to perform measurement restriction, when performing cell reselection measurement, the terminal device will not perform measurements on cells that have been added to the reselection blacklist due to reselection restrictions. When the reselection restriction of a certain cell or a certain frequency point is removed, the cell or all cells under this frequency point can be removed from the reselection blacklist, and the reselection measurement evaluation can be performed again.

Optionally, the measurement restriction may include any of the following: not performing measurement, performing measurement relaxation, and adding cell or frequency point outside the reselection candidate list to the reselection blacklist cell.

For example, when the measurement restriction is to not perform measurements, during the cell reselection process, if the terminal device detects a cell on a certain frequency point and the cell is excluded from the reselection candidate list, then the terminal device may not perform measurements on the cell.

Alternatively, during the cell reselection process, if the terminal device determines that all cells under a certain frequency point are excluded from the reselection candidate list, the terminal device may not perform measurements on the frequency point. In the embodiment, the frequency points for which measurement is not performed can be high-priority frequency points, same-priority frequency points, or low-priority frequency points. This disclosure does not limit this.

Alternatively, during the intra-frequency cell reselection process, if the terminal device determines that all the intra-frequency neighboring cells are excluded from the reselection candidate list, the terminal device may not perform measurements on the intra-frequency cells.

By implementing the embodiments of the present disclosure, the network device sends first indication information to the terminal device, where the first indication information is used to indicate whether to perform measurement restriction on the cell or frequency point outside the reselection candidate list during the cell reselection process.

As a result, the network device instructs the terminal device to limit the measurement of cell or frequency point outside the reselection candidate list and avoids cell or frequency point outside the reselection candidate list from occupying measurement opportunities. This not only ensures the accuracy of the measurement results, but also reduces the power consumption of the terminal device.

Please refer to FIG. 9. FIG. 9 is a schematic flowchart of a cell reselection measurement method provided by another embodiment of the present disclosure. The method is executed by a network device. As shown in FIG. 9, the method may include but is not limited to the following steps:
Step 91: Send second indication information to the terminal device, where the second indication information is used to indicate the active duration of the measurement restriction. Optionally, the active duration T1 of the measurement restriction and the active duration T2 of the reselection restriction may be the same or different, and this disclosure does not limit this.

For example, when the active duration T1 of the measurement restriction is the same as the active duration T2 of the reselection restriction, and the active duration T2 of the reselection restriction is 300 s, then the active duration T1 of the measurement restriction is also 300 s. Alternatively, the active duration T2 of the reselection restriction can be up to 300 s. For example, if T2 is 280 s, then it is determined that the active duration T1 of the measurement restriction is also 280 s. This disclosure does not limit this.

When the active duration T1 of the measurement restriction is different from the active duration T2 of the reselection restriction, and the active duration T2 of the reselection restriction is 300 s, then the active duration T1 of the measurement restriction can be 200 s, 250 s, etc. Alternatively, the active duration T2 of the reselection restriction can be up to 300 s. For example, if T2 is 280 s, then the active duration T1 of the measurement restriction can be 200 s, 260 s, etc. This disclosure does not limit this.

Optionally, the measurement restriction removing time and the reselection restriction removing time may be the same or different, and this disclosure does not limit this.

By implementing the embodiments of the present disclosure, the network device sends the second indication information for indicating the active duration of the measurement restriction to the terminal device, so that the terminal device determines that, in the case of performing measurement restriction on cell or frequency point outside the reselection candidate list, within the active duration of the measurement restriction, measurement restriction is implemented on the cell or frequency point outside the reselection candidate list. As a result, the measurement opportunity is prevented from being occupied by the cell or frequency point outside the reselection candidate list, which not only ensures the accuracy of the measurement results, but also reduces the power consumption of the terminal device.

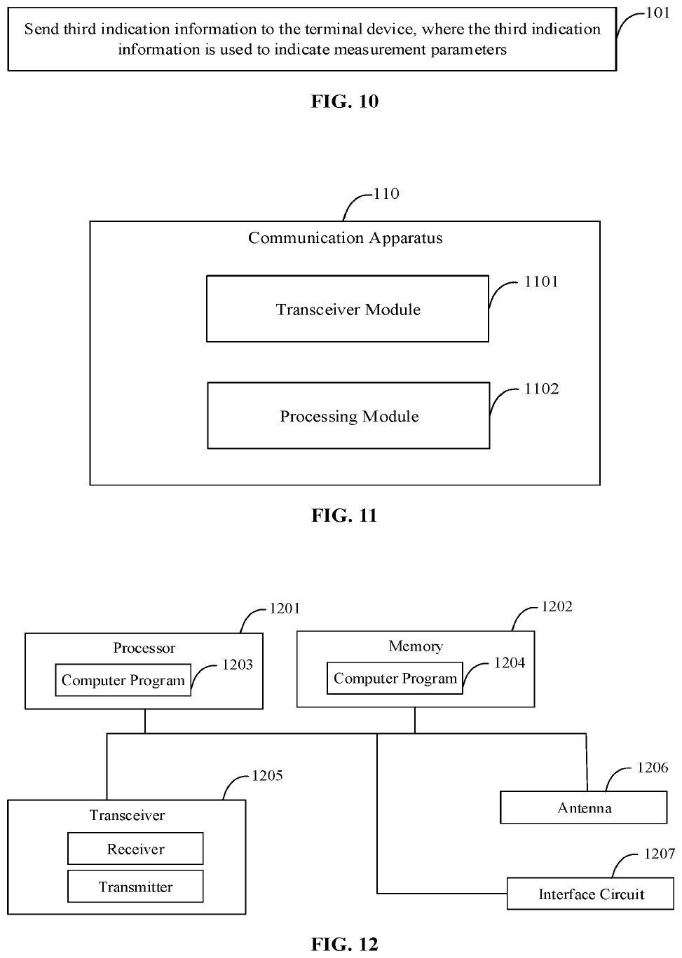

Please refer to FIG. 10. FIG. 10 is a schematic flowchart of a cell reselection measurement method provided by another embodiment of the present disclosure. The method is executed by a network device. As shown in FIG. 10, the method may include but is not limited to the following steps:
Step 101: Send third indication information to the terminal device, where the third indication information is used to indicate measurement parameters. The measurement parameters include at least one of the following: number of measurements and measurement period. The number of measurements may be the number of times that the terminal device performs measurements on cells outside the reselection candidate list instructed by the network device. It can be 1 time, 2 times, N times, etc., and this disclosure does not limit this.

Optionally, the measurement period can also be determined based on the number of measurements. That is, the measurement period is the ratio of the active duration of the measurement restriction to the number of measurements.

Alternatively, the measurement period may also be a specific period agreed upon by the network device according to the protocol. For example, a measurement is performed every 50 seconds, a measurement is performed every 100 seconds, etc. This disclosure does not limit this.

Alternatively, the third indication information sent by the network device may indicate the measurement relaxation factor. The terminal device can then determine the measurement period based on the product of the measurement relaxation factor indicated by the network device and the regular measurement period.

Optionally, the measurement parameters corresponding to different frequency points are different or the same, the measurement parameters corresponding to different cells are different or the same, the measurement parameters corresponding to terminal device in different states are different or the same, or the measurement parameters corresponding to terminal device of different services are different or the same.

By implementing the embodiments of the present disclosure, the network device sends third indication information to the terminal device, where the third indication information is used to indicate measurement parameters, so that the terminal device determines to perform measurements on cell or frequency point outside the reselection candidate list according to the measurement parameters, in the case of performing measurement relaxation on the cell or frequency point outside the reselection candidate list. This avoids cell or frequency point outside the reselection candidate list from occupying too many measurement opportunities, which not only ensures the accuracy of the measurement results, but also reduces the power consumption of the terminal device.

In the above-mentioned embodiments of the present disclosure, the methods provided by the embodiments of the present disclosure are introduced from the perspectives of network device and terminal device. In order to implement the functions in the methods provided by the above embodiments of the present disclosure, network devices and terminal devices may include hardware structures and software modules to implement the above functions in the form of hardware structures, software modules, or hardware structures plus software modules. A certain function among the above functions can be executed by a hardware structure, a software module, or a hardware structure plus a software module.

Please refer to FIG. 11, which is a schematic structural diagram of a communication apparatus 110 provided by an embodiment of the present disclosure. The communication apparatus 110 shown in FIG. 11 may include a processing module 1101 and a Transceiver Module 1102.

The transceiver module 1102 may include a sending module and/or a receiving module. The sending module is used to implement the sending function, and the receiving module is used to implement the receiving function. The transceiver module 1102 may implement the sending function and/or the receiving function.

It can be understood that the communication apparatus 110 may be a terminal device, an apparatus in the terminal device, or an apparatus that can be used in conjunction with the terminal device.

The communication apparatus 110, on the terminal device side, includes a processing module 1101, configured to determine whether to perform a measurement restriction on a cell or frequency point outside a reselection candidate list during a cell reselection process.

Optionally, the measurement restriction comprises any of the following: not performing measurement, performing measurement relaxation, and adding the cell or frequency point outside the reselection candidate list to a reselection blacklist cell.

Optionally, the reselection blacklist cell comprises at least one of the following indicated in a broadcast system message: an intra-frequency blacklisted cell list, an inter-frequency blacklisted cell list, or an inter-system blacklisted cell list.

Optionally, the processing module 1101 is further configured to determine whether to perform the measurement restriction on the cell or frequency point outside the reselection candidate list according to a protocol agreement, or determine whether to perform the measurement restriction on the cell or frequency point outside the reselection candidate list according to first indication information sent by a network device.

Optionally, further comprising a transceiver module 1102, configured to receive the first indication information by a broadcast system messages in a serving cell, or receive the first indication information by a dedicated signaling.

Optionally, the processing module 1101 is further configured to determine an active duration of the measurement restriction according to second indication information of the network device, or determine the active duration of the measurement restriction according to a protocol agreement.

Optionally, performing measurement relaxation comprises determining at least one of following measurement parameters number of measurements or measurement period.

Optionally, the processing module 1101 is further configured to perform at least one measurement on the cell or frequency point outside the reselection candidate list in each measurement period.

Optionally, the processing module 1101 is further configured to determine the measurement parameters according to third indication information of the network device, or determine the measurement parameters according to a protocol agreement.

Optionally, the measurement parameters corresponding to different frequency points are different or same, the measurement parameters corresponding to different cells are different or same, the measurement parameters corresponding to terminal device in different states are different or same, or the measurement parameters corresponding to terminal device of different services are different or same.

Optionally, the processing module 1101 is further configured to, in response to any measurement period being aligned with a discontinuous reception DRX cycle, perform at least one measurement on the cell or frequency point outside the reselection candidate list in the any measurement period, or, in response to any measurement period being misaligned with the DRX cycle, perform at least one measurement on the cell or frequency point outside the reselection candidate list in the DRX cycle after the any measurement period.

Optionally, the terminal device is configured with extended DRX, and the processing module 1101 is further configured to, in a case that it is determined to perform measurement restriction on the cell or frequency point outside the reselection candidate list, in response to determining that there is a paging time window PTW within an active duration of the measurement restriction, perform at least one measurement on the cell or frequency point outside the reselection candidate list in the DRX cycle of the PTW.

Optionally, the processing module 1101 is further configured to, in response to determining that one PTW exists within the active duration of the measurement restriction, perform at least one measurement on the cell or frequency point outside the reselection candidate list in the DRX cycle of the one PTW, or, in response to determining that at least two PTWs exist within the active duration of the measurement restriction, perform at least one measurement on the cell or frequency point outside the reselection candidate list in the DRX cycle of at least one PTW among the at least two PTWs.

Optionally, the terminal device is configured with extended DRX, and wherein the processing module 1101 is further configured to, in a case that it is determined to perform measurement restriction on the cell or frequency point outside the reselection candidate list, in response to determining that there is no paging time window PTW within an active duration of the measurement restriction, not perform measurement on the cell or frequency point outside the reselection candidate list.

Optionally, the cell reselection process comprises at least one of the following: intra-frequency cell reselection, inter-frequency cell reselection, or inter-system cell reselection.

In the communication apparatus provided by the present disclosure, the terminal device determines whether to perform measurement restriction on cell or frequency point outside the reselection candidate list during the cell reselection process. As a result, the terminal device restricts the measurement of cell or frequency point outside the reselection candidate list and avoids cell or frequency point outside the reselection candidate list from occupying measurement opportunities. This not only ensures the accuracy of the measurement results, but also reduces the power consumption of the terminal device.

It can be understood that the communication apparatus 110 may be a network device, an apparatus in the network device, or an apparatus that can be used in conjunction with the network device.

The communication apparatus 110, on the network device side, includes a transceiver module 1102, configured to send first indication information to a terminal device, wherein the first indication information is configured to indicate whether to perform a measurement restriction on a cell or frequency point outside a reselection candidate list during a cell reselection process.

Optionally, the measurement restriction comprises any of the following: not performing measurement, performing measurement relaxation, and adding the cell or frequency point outside the reselection candidate list to a reselection blacklist cell.

Optionally, the reselection blacklist cell comprises at least one of the following indicated in a broadcast system message: an intra-frequency blacklisted cell list, an inter-frequency blacklisted cell list, or an inter-system blacklisted cell list.

Optionally, the transceiver module 1102 is further configured to:
send the first indication information to the terminal device by a broadcast system messages in a serving cell, or send the first indication information to the terminal device by a dedicated signaling.

Optionally, the transceiver module 1102 is further configured to sending second indication information to the terminal device, wherein the second indication information is configured to indicate an active duration of the measurement restriction.

Optionally, the transceiver module 1102 is further configured to send third indication information to the terminal device, wherein the third indication information is configured to indicate measurement parameters, and wherein the measurement parameters comprise at least one of following: number of measurements; or measurement period. Optionally, the measurement parameters corresponding to different frequency points are different or same, the measurement parameters corresponding to different cells are different or same, the measurement parameters corresponding to terminal device in different states are different or same, or the measurement parameters corresponding to terminal device of different services are different or same.

Optionally, the cell reselection process comprises at least one of the following intra-frequency cell reselection, inter-frequency cell reselection, or inter-system cell reselection.

In the communication apparatus provided by the present disclosure, the network device sends first indication information to the terminal device, where the first indication information is used to indicate whether to perform measurements restriction on cell or frequency point outside the reselection candidate list during the cell reselection process. As a result, the network device instructs the terminal device to restrict the measurement of cell or frequency point outside the reselection candidate list, thereby preventing cell or frequency point outside the reselection candidate list from occupying measurement opportunities, which not only ensures the accuracy of the measurement results, but also reduces the power consumption of terminal device.

Please refer to FIG. 12, which is a schematic structural diagram of another communication apparatus 120 provided by an embodiment of the present disclosure. The communication apparatus 120 may be an network device, or may be a terminal device, or may be a chip, a chip system, a processor or the like that supports the network device to implement the above method, or may be a chip, a chip system, a processor or the like that supports the terminal device to implement the above method. The device can be used to implement the method described in the above method embodiments. For details, reference may be made to the description in the above method embodiments.

The communication apparatus 120 may include one or more processors 1201. The processor 1201 may be a general-purpose processor or a dedicated processor, or the like. For example, the processor 1201 may be a baseband processor or a central processing unit. The baseband processor can be used to process communication protocols and communication data. The central processor can be used to control the communication apparatus (such as base stations, baseband chips, terminal devices, terminal device chips, DU or CU, or the like), execute computer programs, and process data for the computer programs.

Optionally, the communication apparatus 120 may also include one or more memories 1202, on which a computer program 1204 may be stored. The processor 1201 executes the computer program 1204, so that the communication apparatus 120 performs the method described in the above method embodiments. Optionally, the memory 1202 may also store data. The communication apparatus 120 and the memory 1202 can be provided separately or integrated together.

Optionally, the communication apparatus 120 may also include a transceiver 1205 and an antenna 1206. The transceiver 1205 may be referred to as a transceiver unit, a transceiver, a transceiver circuit, or the like, and is used to implement transceiver functions. The transceiver 1205 may include a receiver and a transmitter. The receiver may be referred to as a receiver or a receiving circuit, or the like, and is used to implement the receiving function; and the transmitter may be referred to as a transmitter, a transmitting circuit, or the like, and is used to implement the transmitting function.

Optionally, the communication apparatus 120 may also include one or more interface circuits 1207. The interface circuit 1207 is used to receive code instructions and transmit the code instructions to the processor 1201. The processor 1201 executes the code instructions to cause the communication apparatus 120 to perform the method described in the above method embodiments.

The communication apparatus 120 is a terminal device: the processor 1201 is used to perform step 21 in FIG. 2; step 31 and step 32 in FIG. 3; step 41, step 42 and step 43 in FIG. 4; and step 51, step 52 and step 53 in FIG. 5, etc.

The communication apparatus 120 is a network device: the transceiver 1205 is used to perform step 81 in FIG. 8; step 91 in FIG. 9; and step 101 in FIG. 10, etc.

In one implementation, the processor 1201 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The above-mentioned transceiver circuit, interface or interface circuit can be used for reading and writing codes/data, or the above-mentioned transceiver circuit, interface or interface circuit can be used for signal transmission or transfer.

In one implementation, the processor 1201 may be stored with a computer program 1203, and the computer program 1203 is executed by the processor 1201, causing the communication apparatus 120 to perform the method described in the above method embodiments. The computer program 1203 may be solidified in the processor 1201, in which case the processor 1201 may be implemented by hardware.

In one implementation, the communication apparatus 120 may include a circuit, and the circuit may implement the functions of sending or receiving or communicating in the foregoing method embodiments. The processors and transceivers described in this disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication apparatus described in the above embodiments may be a network device or a terminal device, but the scope of the communication apparatus described in this disclosure is not limited thereto, and the structure of the communication apparatus may not be limited by FIG. 12. The communication apparatus may be a stand-alone device or may be part of a larger device. For example, the communication apparatus may be:
(1) a stand-alone integrated circuit IC, or chip, or chip system or subsystem;
(2) a set of one or more ICs. Optionally, the IC set may also include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

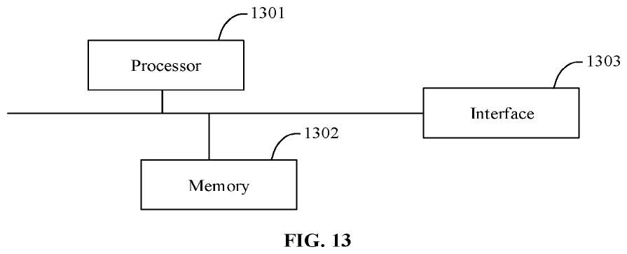

For the case where the communication apparatus may be a chip or a chip system, reference may be made to the schematic structural diagram of the chip shown in FIG. 13. The chip shown in FIG. 13 includes a processor 1301 and an interface 1302. The processor 1301 may include one or more processors, and the interface 1302 may include multiple interfaces.

For the case where the chip is used to implement the functions of the terminal device in the embodiment of the present disclosure:

The processor 1301 is configured to execute the step 21 in FIG. 2; step 31 and step 32 in FIG. 3; step 41, step 42 and step 43 in FIG. 4; or step 51, step 52 and step 53 in FIG. 5, etc.

For the case where the chip is used to implement the functions of the network device in the embodiment of the present disclosure:

The interface 1302 is configured to execute the step 81 in FIG. 8; step 91 in FIG. 9; and step 101 in FIG. 10, etc.

Optionally, the chip also includes a memory 1303, which is used to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure also provide a communication system. The system includes a communication apparatus as a terminal device and a communication apparatus as a network device in the embodiment of FIG. 11, or the system includes a communication apparatus as a terminal network device and a communication apparatus as a network device in the embodiment of FIG. 12.

The present disclosure also provides a computer-readable storage medium on which instructions are stored. When the instructions are executed by a computer, the functions of any of the above method embodiments are implemented.

The present disclosure also provides a computer program product, which, when been executed by a computer, implements the functions of any of the above method embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in this disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The corresponding relationships shown in each table in this disclosure can be configured or predefined. The values of the information in each table are only examples and can be configured as other values, which is not limited by this disclosure. When configuring the correspondence between information and each parameter, it is not necessarily required to configure all the correspondences shown in each table. For example, in the table in this disclosure, the corresponding relationships shown in some rows may not be configured. For another example, appropriate deformation adjustments can be made based on the above table, such as splitting, merging, or the like. The names of the parameters shown in the titles of the above tables may also be other names understandable by the communication apparatus, and the values or expressions of the parameters may also be other values or expressions understandable by the communication apparatus. When implementing the above tables, other data structures can also be used, such as arrays, queues, containers, stacks, linear lists, pointers, linked lists, trees, graphs, structures, classes, heaps, hash tables, or the like.

Predefinition in this disclosure may be understood as definition, pre-definition, storage, pre-storage, pre-negotiation, pre-configuration, firming, or pre-burning.

Those of ordinary skill in the art will appreciate that the units and algorithm steps of each example described in conjunction with the embodiments disclosed herein can be implemented with electronic hardware, or a combination of computer software and electronic hardware. Whether these functions are implemented in hardware or software depends on the specific application and design restrictions of the technical solution. Those skilled in the art may implement the described functions using different methods for each specific application, but such implementations should not be considered to be beyond the scope of this disclosure.

Those skilled in the art can clearly understand that for the convenience and simplicity of description, the specific operating processes of the systems, devices and units described above can be referred to the corresponding processes in the foregoing method embodiments, which will not be described again here.

The above are only specific embodiments of the present disclosure, but the protection scope of the present disclosure is not limited thereto. Any changes or substitutions easily conceivable to those skilled in the art within the technical scope disclosed in the present disclosure should be covered by the protection scope of this disclosure. Therefore, the protection scope of the present disclosure should be subject to the protection scope of the claims.

1. A method of cell reselection measurement, executed by a terminal device, and the method comprising:
during a cell reselection process, determining whether to perform a measurement restriction on a cell or frequency point outside a reselection candidate list.

2. The method according to claim 1, wherein the measurement restriction comprises any of the following: not performing measurement, performing measurement relaxation, and adding the cell or frequency point outside the reselection candidate list to a reselection blacklist cell.

3. (canceled)

4. The method according to claim 1, wherein the determining whether to perform the measurement restriction on the cell or frequency point outside the reselection candidate list comprises:
determining whether to perform the measurement restriction on the cell or frequency point outside the reselection candidate list according to a protocol agreement;
or,
determining whether to perform the measurement restriction on the cell or frequency point outside the reselection candidate list according to first indication information sent by a network device.

5. The method according to claim 4, wherein the according to first indication information sent by the network device comprises:
receiving the first indication information by a broadcast system messages in a serving cell;
or,
receiving the first indication information by a dedicated signaling.

6. The method according to claim 1, further comprising:
determining an active duration of the measurement restriction according to second indication information of the network device;
or,
determining the active duration of the measurement restriction according to a protocol agreement.

7. The method according to claim 2, wherein performing measurement relaxation comprises determining at least one of following measurement parameters:
number of measurements; or
measurement period.

8. The method according to claim 7, further comprising:
performing at least one measurement on the cell or frequency point outside the reselection candidate list in each measurement period.

9. The method according to claim 7, further comprising:
determining the measurement parameters according to third indication information of the network device;
or,
determining the measurement parameters according to a protocol agreement.

10. The method according to claim 7, wherein:
the measurement parameters corresponding to different frequency points are different or same;
or,
the measurement parameters corresponding to different cells are different or same;
or,
the measurement parameters corresponding to terminal device in different states are different or same;
or,
the measurement parameters corresponding to terminal device of different services are different or same.

11. The method according to claim 8, wherein the performing at least one measurement on the cell or frequency point outside the reselection candidate list in each measurement period comprises:
in response to any measurement period being aligned with a discontinuous reception DRX cycle, performing at least one measurement on the cell or frequency point outside the reselection candidate list in the any measurement period;
or,
in response to any measurement period being misaligned with the DRX cycle, performing at least one measurement on the cell or frequency point outside the reselection candidate list in the DRX cycle after the any measurement period.

12. The method according to claim 1, wherein the terminal device is configured with extended DRX, and the method further comprises:
in a case that it is determined to perform measurement restriction on the cell or frequency point outside the reselection candidate list, in response to determining that there is a paging time window PTW within an active duration of the measurement restriction, performing at least one measurement on the cell or frequency point outside the reselection candidate list in the DRX cycle of the PTW.

13. The method according to claim 12, wherein, the in response to determining that there is the paging time window PTW within the active duration of the measurement restriction, performing at least one measurement on the cell or frequency point outside the reselection candidate list in the DRX cycle of the PTW, comprises:
in response to determining that one PTW exists within the active duration of the measurement restriction, performing at least one measurement on the cell or frequency point outside the reselection candidate list in the DRX cycle of the one PTW;
or,
in response to determining that at least two PTWs exist within the active duration of the measurement restriction, performing at least one measurement on the cell or frequency point outside the reselection candidate list in the DRX cycle of at least one PTW among the at least two PTWs.

14. The method according to claim 1, wherein the terminal device is configured with extended DRX, and the method further comprises:
in a case that it is determined to perform measurement restriction on the cell or frequency point outside the reselection candidate list, in response to determining that there is no paging time window PTW within an active duration of the measurement restriction, not performing measurement on the cell or frequency point outside the reselection candidate list.

15. (canceled)

16. A method of cell reselection measurement, executed by a network device, and the method comprising:
sending first indication information to a terminal device, wherein the first indication information is configured to indicate whether to perform a measurement restriction on a cell or frequency point outside a reselection candidate list during a cell reselection process.

17. The method according to claim 16, wherein the measurement restriction comprises any of the following: not performing measurement, performing measurement relaxation, and adding the cell or frequency point outside the reselection candidate list to a reselection blacklist cell.

18-19. (canceled)

20. The method according to claim 16, further comprising:
sending second indication information to the terminal device, wherein the second indication information is configured to indicate an active duration of the measurement restriction.

21. The method according to claim 16, further comprising:
sending third indication information to the terminal device, wherein the third indication information is configured to indicate measurement parameters, and wherein the measurement parameters comprise at least one of following: number of measurements; or measurement period.

22. The method according to claim 21, wherein:
the measurement parameters corresponding to different frequency points are different or same;
or,
the measurement parameters corresponding to different cells are different or same;
or,
the measurement parameters corresponding to terminal device in different states are different or same;
or,
the measurement parameters corresponding to terminal device of different services are different or same.

23-46. (canceled)

47. A communication apparatus, comprising a processor and a memory, a computer program is stored in the memory, and the processor executes the computer program stored in the memory, to cause the apparatus to execute a method of cell reselection measurement, executed by a terminal device, and the method comprising:
during a cell reselection process, determining whether to perform a measurement restriction on a cell or frequency point outside a reselection candidate list.

48. A communication apparatus, comprising a processor and a memory, a computer program is stored in the memory, and the processor executes the computer program stored in the memory, to cause the apparatus to execute the method according to claim 16.

49-52. (canceled)
